(19) United States
(12) Patent Application Publication
(10) Pub. No.: US 2013/0134818 A1
(43) Pub. Date: May 30, 2013

(54) THREE-PHASE AXIAL FLUX MOTOR AND MAGNETIC PATH ADJUSTING METHOD THEREOF

(71) Applicant: DELTA ELECTRONICS, INC., Kuei San (TW)

(72) Inventors: Hsun-Hao JAN, Kuei San (TW); Chin-Chun LAI, Kuei San (TW); Kun-Fu CHUANG, Kuei San (TW)

(73) Assignee: DELTA ELECTRONICS, INC., Kuei San (TW)

(21) Appl. No.: 13/682,144

(22) Filed: Nov. 20, 2012

(30) Foreign Application Priority Data
Nov. 28, 2011 (CN) 201110384833.9

(51) Int. Cl. H02K 15/00; H02K 3/12; H02K 21/24

(52) U.S. Cl. CPC H02K 15/0006; H02K 21/24; H02K 3/12
USPC 310/156.32; 29/596; 29/598

(57) ABSTRACT

A three-phase axial flux motor is disclosed. The axial flux motor includes a stator, a rotor and a driving unit. The stator includes three coils. The rotor is pivotally disposed on the stator and includes a magnet which has a magnetizing state. The driving unit outputs a sinusoidal phase voltage to the coils. The magnetizing state of the magnet is corresponding to the inductance waveform and the IEF (induced electromotive force) waveform of the stator to let the waveform of the driving phase current to be an approximative sine wave.

### CROSS REFERENCE TO RELATED APPLICATIONS

This Non-provisional application claims priority under 35 U.S.C. §119(a) on Patent Application No(s). 201110384833.9 filed in People's Republic of China on Nov. 28, 2011, the entire contents of which are hereby incorporated by reference.

### BACKGROUND OF THE INVENTION

1. Field of Invention

The invention relates to a three-phase axial flux motor and the magnetic path adjusting method thereof. In particularly, the invention relates to a three-phase axial flux motor with core and the magnetic path adjusting method thereof.

2. Related Art

Motors can be divided into radial flux motors and axial flux motors. The flux direction of the radial flux motor is the same to the diameter direction, while the flux direction of the axial flux motor is the same to the direction of the shaft. Therefore the axial length of the axial flux motor can be reduced to minimize the motor, and the axial flux motor has a large flux area for providing the desired performance. Thus, the axial flux motor has the advantages of high power density and compact size, and is widely used in applications such as hard disc drives, robot joints, fans, small electric vehicle drives, wind power facilities, and flying vehicle thrusts which have considerable space limitations.

However, due to the structure of axial magnetic permeability, it is difficult to fabricate a core of silicon steel sheets. An axial air gap-type motor is poor at its power performance, and suffers from the problem of high frequency noises.

Therefore, it is an important subject to provide an axial flux motor having a low high-frequency noise with the power performance effectively improved.

### SUMMARY OF THE INVENTION

In view of the foregoing subject, an objective of the invention is to provide a three-phase axial flux motor and the magnetic path adjusting method thereof, which has a low high-frequency noise with the power performance effectively improved.

To achieve the above objective, the present invention discloses a three-phase axial flux motor, which comprises a stator, a rotor and a driving unit. The stator comprises three coils. The rotor, which is pivotally connected at the stator, comprises a magnet having a magnetizing state. The driving unit outputs a sinusoidal phase voltage to the coils. The magnetizing state of the magnet is provided in correspondence to an inductance waveform and an IEF (induced electromotive force) waveform to let a waveform of a driving phase current flowing through the coils be an approximative sine wave.

In one embodiment, the stator comprises a core, the core has a plurality of slots, the number of the slots is a multiple of three, and the coils are wound at the slots.

In one embodiment, the inductance waveform and the IEF waveform of the stator are approximative sine waves.

In one embodiment, the ripple error of the inductance waveform in each phase is 78% to 80%, and the maximum value difference and the minimum value difference between the phases are less than 1%.

In one embodiment, the difference between the waveform area of the IEF waveform and the waveform area of the sine wave having the same peak value and period is less than 5%.

In one embodiment, the core is made of a soft magnetic composite material.

In one embodiment, the driving unit is a PWM (pulse width modulation) driving unit.

In one embodiment, the magnetizing state of the magnet comprises the number, the shape, the distribution and the strength of magnet poles.

In one embodiment, the stator further comprises an insulation frame mounted on the core, and the coils are wound at the insulation frame.

To achieve the above objective, the present invention also discloses a magnetic path adjusting method of a three-phase axial flux motor, comprising the steps of: providing the three-phase flux motor, wherein the motor comprises a stator and a rotor; driving the rotor to rotate by another motor, wherein the stator generates an inductance waveform and an IEF (induced electromotive force) waveform; adjusting the inductance waveform and the IEF waveform of the stator; and inputting a sinusoidal driving phase voltage to three coils of the stator to let the driving phase current flowing through the three coils be an approximative sine wave.

In one embodiment, the step of adjusting the inductance waveform and the IEF waveform of the stator is to adjust the inductance waveform and the IEF waveform to be approximative sine waves.

In one embodiment, the inductance waveform and the IEF waveform are adjusted by adjusting a magnetizing state of a magnet of the rotor.

In one embodiment, the shape of the coils of the stator and the design of the shape of the slots are modified to adjust the inductance waveform and the IEF waveform.

In one embodiment, the difference between the waveform area of the adjusted IEF waveform and the waveform area of the ideal sine wave having the same peak value and period is less than 5%.

In one embodiment, the ripple error of the adjusted inductance waveform in each phase is 78% to 80%, and the maximum value difference and the minimum value difference between the phases are less than 1%.

As mentioned above, the three-phase axial flux motor of the invention includes a stator, a rotor and a driving unit. The driving unit outputs a sinusoidal phase voltage to the coil to generate a driving phase current. When the rotor rotates stably, the coil of the stator generates an inductance waveform and an induced electromotive force waveform. By adjusting the slots of the stator, the design of the coil, or the magnetizing state of the magnet, the inductance waveform and the induced electromotive force waveform are adjusted. The difference between the area of the adjusted induced electromotive force waveform and the area of the ideal sine wave having the same peak value and period should be less than 5%. Subsequently, the driving phase current is generated to flow through the coil to excite the magnetic fields of the stator and the rotor to drive the rotor to rotate stably. The method of adjusting the magnetic path of the three-phase axial flux motor of the invention adjusts the inductance waveform and the induced electromotive force waveform of the three-phase axial flux motor to approach an ideal sine wave. Afterwards, a sinusoidal phase voltage is input to the coil to generate a driving phase current having an approximative sine wave to reduce the high frequency noise during operation and effectively improve the power performance.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1A is a system block diagram of the three-phase axial flux motor of the preferred embodiment of the invention;

FIG. 1B is a partial explosive schematic diagram showing the three-phase axial flux motor of the preferred embodiment of the invention;

FIG. 2A is a schematic diagram showing another aspect of the stator of the preferred embodiment of the invention;

FIG. 2B is a schematic diagram showing still another aspect of the stator of the preferred embodiment of the invention;

FIG. 2C is a schematic diagram showing still further another aspect of the stator of the preferred embodiment of the invention;

FIG. 3 is a schematic diagram showing the magnetizing state of the magnet of the preferred embodiment of the invention;

FIG. 4 is a flowchart showing the steps of the magnetic path adjusting method of the three-phase axial flux motor of the preferred embodiment of the invention;

FIG. 5 is a circuit diagram of a portion of the three-phase axial flux motor of the preferred embodiment of the invention;

FIG. 6 is a schematic diagram of the three-phase inductance waveform of the preferred embodiment of the invention; and

FIG. 7 is a schematic diagram of the induced electromotive force waveform of a single phase of the preferred embodiment of the invention and a sine wave.

### DETAILED DESCRIPTION OF THE INVENTION

The present invention will be apparent from the following detailed description, which proceeds with reference to the accompanying drawings, wherein the same references relate to the same elements.

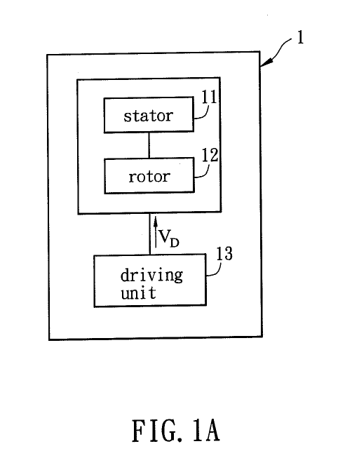

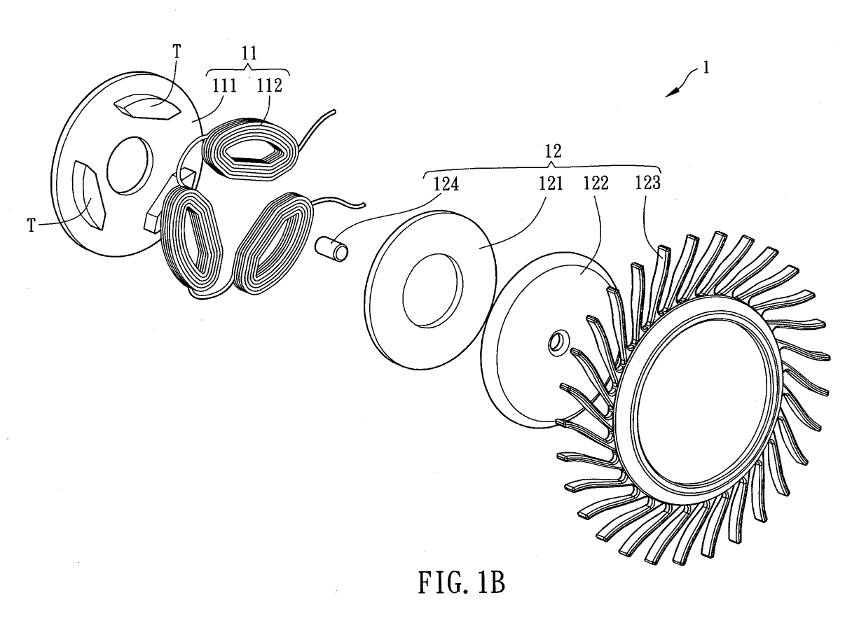

FIG. 1A is a system block diagram of a three-phase axial flux motor 1 of the preferred embodiment of the invention, and FIG. 1B is a partial explosive schematic diagram showing the three-phase axial flux motor 1. As shown in FIGS. 1A and 1B, the three-phase axial flux motor 1 includes a stator 11, a rotor 12 and a driving unit 13.

The stator 11 includes a core 111 and three coils 112. The core 111 has a plurality of slots T, and the number of the slots T is a multiple of three such as three or six. In the present embodiment, three slots T are provided at the core 111 as an example. The shapes of the slots T may be triangles, rectangles, polygons including pentagons, circles, ellipses, fans or the combinations thereof without limitation herein. Moreover, the core 111 of the present embodiment is made of a soft magnetic composite (SMC).

The coils 112 are wound at the slots T. Since the slots T disposed at the core 111 are independently disposed, the coils 112 may be formed by being divided into three sets and wound at the slots T respectively, or by winding one set of coil 112 at three slots T using a single copper wire. In the present embodiment, the coils are formed by winding one set of coil 112 at three slots T using one single copper wire. That is, the coils 112 wound at the slots T are connected in series.

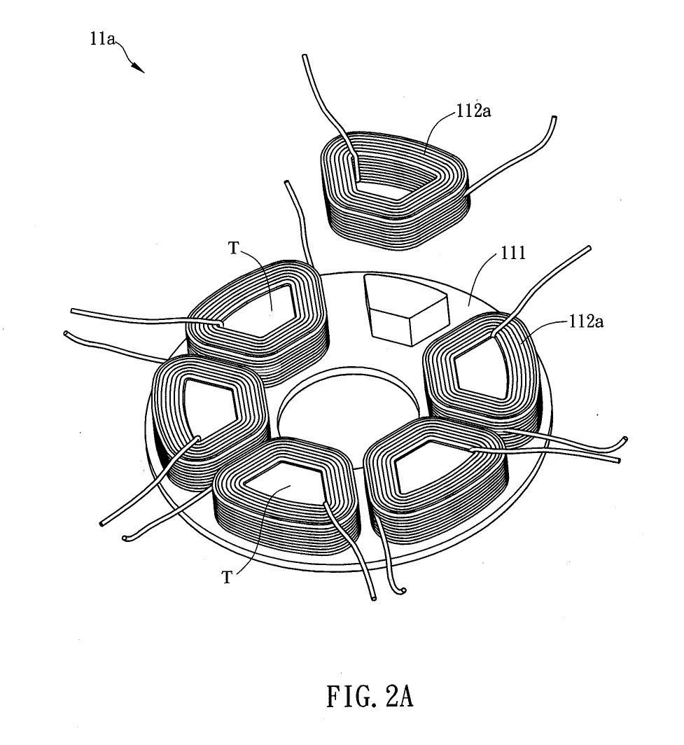

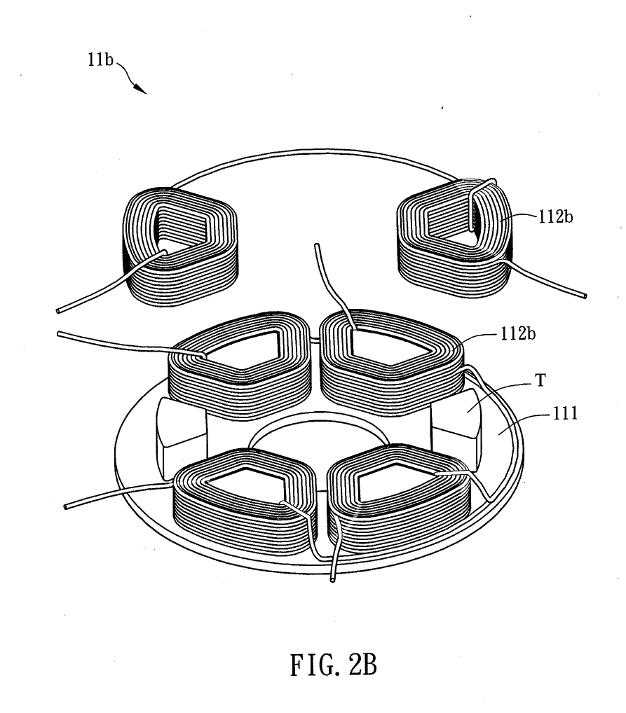

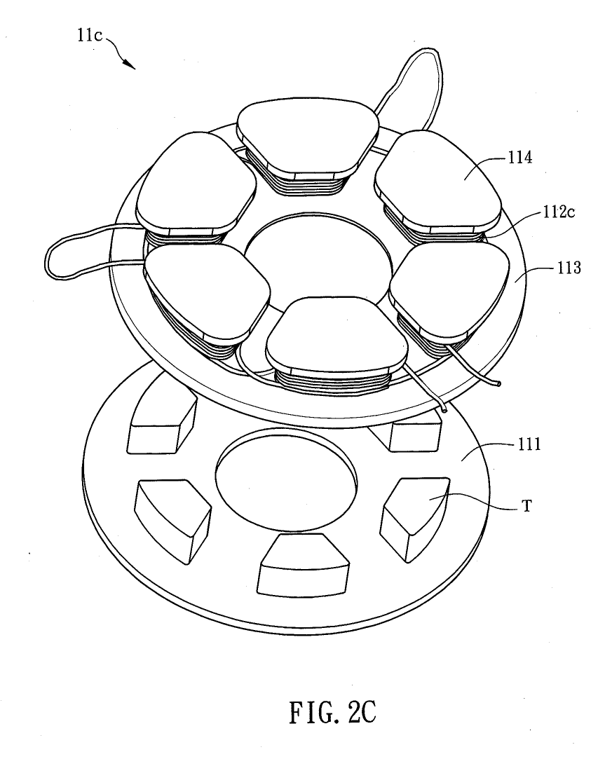

FIGS. 2A to 2C are schematic diagrams showing different aspects of the stator. Six slots T are disposed at the cores 111 in FIGS. 2A, 2B and 2C, respectively, and the differences will be described hereinbelow. In the stator 11a shown in FIG. 2A, six coils 112a are wound at the slots T respectively, and then the coils 112a at opposite two slots T are connected together, so that the coils 112a of the same phase are connected in series. In the stator 11b shown in FIG. 2B, three coils 112b are wound at two opposite slots T, respectively. The coils 112b of the same phase are wound continuously using a single copper wire, so that the coils 112b of the same phase are connected together in series. In the stator 11c shown in FIG. 2C, a tooth portion (not shown in the drawing) is further included with an insulation frame 113 and the caps 114. The insulation frame 113 is set at the core 111 and the slots T, the caps 114 are disposed in parallel with the insulation frame 113. The insulation frame 113 and the caps 114 are connected via the tooth portion, and the coils 112c are wound at the tooth portion.

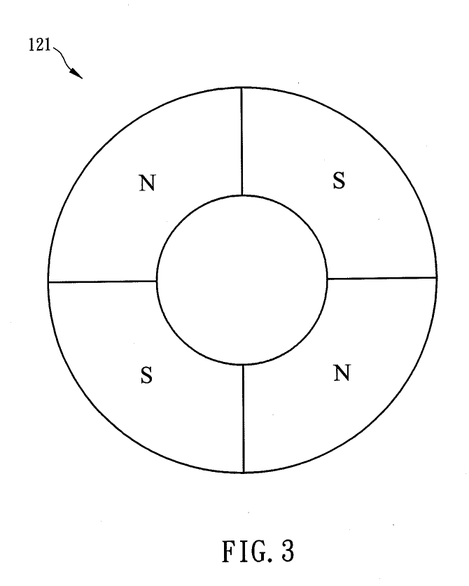

The rotor 12 is pivotally connected to and disposed above the stator 11, and includes a magnet 121, a rotor back steel 122, a blade 123 and a rotor axle 124. The magnet 121 has a magnetizing state. FIG. 3 is a schematic of the magnetizing state of the magnet of the invention. Referring to FIG. 3, the magnetizing state of the magnet 121 includes the number of magnet poles, the shape of magnet poles, the distribution of magnet poles and the magnetic strength. In the present embodiment, two fan-shaped S-poles and two N-poles are taken as an example without limiting sense. The numbers and shapes of magnetic poles may be designed differently in view of different requirements, and the magnetic strengths distributions of the magnetic poles may be adjusted. But regardless of the sizes of the magnetic poles, the total number of the S poles and the N poles is a multiple of four.

Referring to FIG. 1A, the driving unit 13 outputs a sinusoidal phase voltage to the coils of the stator. Under the interaction of the sinusoidal inductance waveform and the sinusoidal induced electromotive force waveform of the rotor and the stator, a driving phase current is generated to the coils 112. The magnetizing state of the magnet 121 is provided corresponding to the inductance waveform and the induced electromotive force waveform of the three-phase axial flux motor 1, so that the inductance waveform and the induced electromotive force waveform of the three-phase axial flux motor 1 are approximative sine waves, and the waveform of the sinusoidal phase current is also sinusoidal. In the present embodiment, the driving unit 13 is a pulse width modulation driving unit. Therefore, the pulse width and the peak value of the output sinusoidal phase current may be adjusted by the driving unit 13.

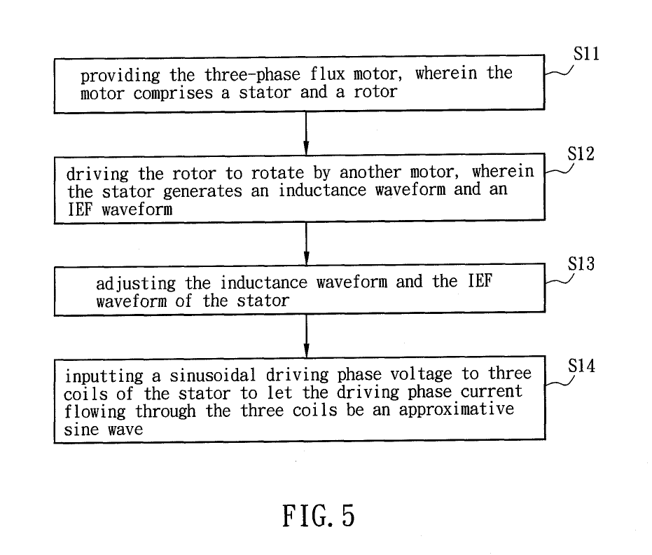

FIG. 5 is a circuit diagram of a portion of the three-phase axial flux motor 1 of the preferred embodiment of the invention. Referring to FIGS. 1A, 1B and 5, the driving unit 13 outputs three sinusoidal phase voltages to the three-phase coils 112 respectively. Under the interactions of the stator sinusoidal inductance waveform and the sinusoidal induced electromotive force waveform, three driving phase currents I_{D1}, I_{D2} and I_{D3} are generated to output to the three-phase coils 112. The coils 112 can be treated as a serially connected circuit of the resistor R and the inductor L.

The above describes the structure of the three-phase axial flux motor 1 of the invention. The magnetic path adjusting method of the three-phase axial flux motor 1 will be described in detail hereinbelow with reference to the same drawings (FIGS. 1A and 1B) with the practical application of the three-phase axial flux motor 1 as an example. For convenience purpose, the actions of adjusting the magnetic path of the axial flux motor 1 as shown in FIGS. 1A and 1B will be used as an example.

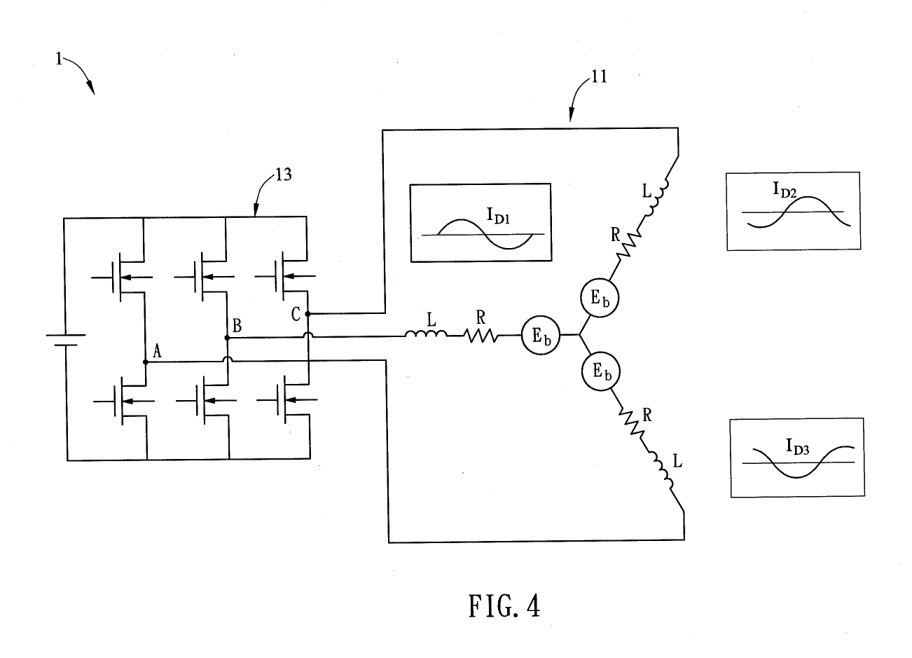

FIG. 4 is a flowchart showing the steps of the magnetic path adjusting method of the three-phase axial flux motor of the preferred embodiment of the invention. With reference to FIGS. 1A, 1B and 4, the magnetic path adjusting method of the present embodiment includes steps S11 to S14.

In step S11, an axial flux motor 1 is provided. The motor 1 includes a stator 11, a rotor 12 and a driving unit 13. The stator 11 includes a core 111 and three coils 112. The core 111 has a plurality of slots T, and the coils 112 are wound at slots T.

In step S12, the rotor 12 is driven to rotate by another motor. The stator 11 generates an inductance waveform and an induced electromotive force waveform. In details, after the driving unit 13 receives electricity, a sinusoidal phase voltage V_{D} is output by a pulse width modulation signal to coils 112 to generate the driving phase current.

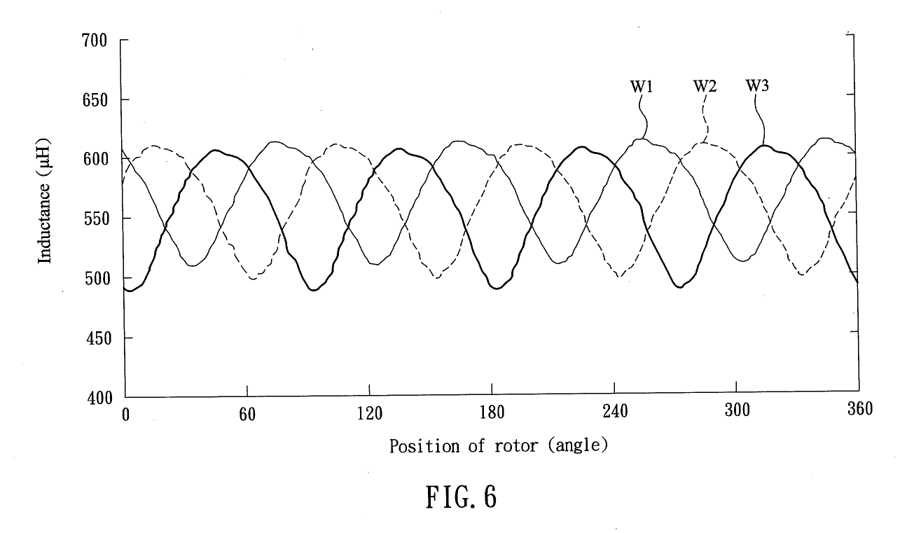

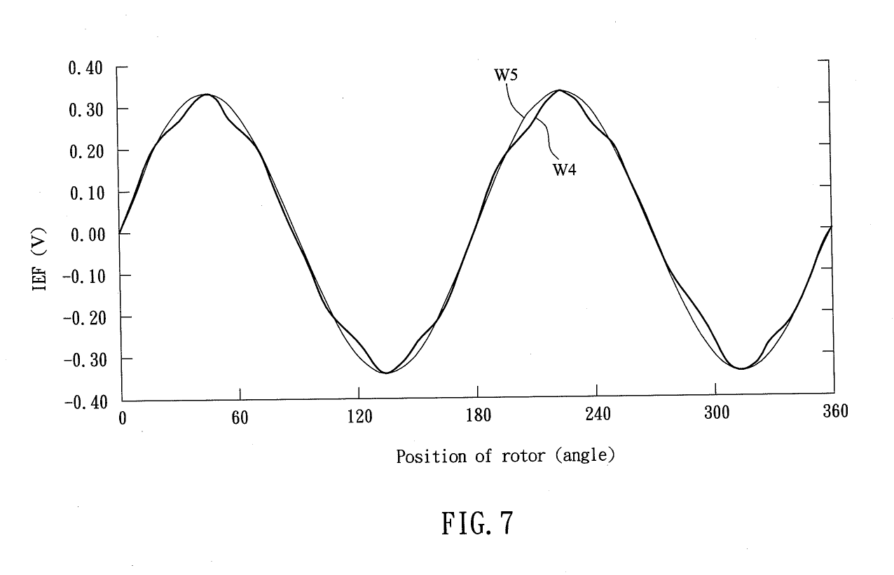

FIG. 6 is a schematic diagram of the three-phase inductance waveform of the preferred embodiment of the invention, and FIG. 7 is a schematic diagram of the induced electromotive force waveform of a single phase of the preferred embodiment of the invention and a sine wave. Referring to FIG. 1A, 6 and 7, three inductance waveforms W1, W2 and W3 and an induced electromotive force waveform W4 are generated by the stator 11 and the rotor 12 according to the driving phase current I_{D}, wherein the inductance waveforms W1, W2 and W3 and the induced electromotive force waveform W4 are approximative sine waves. The inductance waveforms W1, W2 and W3 and the induced electromotive force waveform W4 are also the inductance waveforms W1, W2 and W3 and the induced electromotive force waveform W4 of the three-phase axial flux motor 1. It is noteworthy that the ripple error of each phase of the inductance waveforms W1, W2, and W3 of the three-phase axial flux motor 1 is about 78% to 80%, and the maximum value difference and the minimum value difference between phases are less than 1% (as shown in FIG. 6).

In step S13, the induced electromotive force waveform W4 generated by the stator 11 and the rotor 12 are adjusted so that it has the same peak value and period as the ideal sine wave W5. The difference between the waveform area of the adjusted induced electromotive force waveform W4 and the area of the sine wave W5 having ideal peak value and period is less than 5%. If the adjusted induced electromotive force waveform W4 does not have the same peak value and period as the ideal sine wave W5, or the area difference exceeds 5%, the step S15 will be performed repeatedly to adjust the induced electromotive force waveform W4 of the stator 11 and the rotor 12 for optimization. The ideal sine wave W5 is defined by a define method to obtain the ideal sine wave that is suitable for the three-phase axial flux motor 1 (see FIG. 7).

It should be noted that in the present embodiment, two methods of adjusting the induced electromotive force waveform W4 of the stator 11 and the rotor 12 are listed. One method is to adjust the magnetizing state of the magnet 121 of the rotor 12 to adjust the inductance waveforms W1, W2 and W3 and the induced electromotive force waveform W4. In details, the number, the shapes, the distributions and the strengths of the magnetic poles are modified so that the magnetizing state of the magnet 121 are adjusted accordingly, which results in that the inductance waveforms W1, W2 and W3 and the induced electromotive force waveform W4 generated by the stator 11 and the rotor 12 are also changed accordingly. By adjusting the magnetizing state of the magnet 121, the induced electromotive force waveform W4 of the axial flux motor 1 can approach the ideal sine wave W5.

Another method is to adjust the inductance waveforms W1, W2 and W3 and the induced electromotive force waveform W4 by adjusting the shape of the coils 112 of the stator 11 or the shape of the slots T. In details, as the shape of the coils 112 of the stator 11 or the shape of the slots T is modified, the inductance waveforms W1, W2 and W3 and the induced electromotive force waveform W4 generated by the stator 11 and the rotor 12 can be changed accordingly. Thus the induced electromotive force waveform W4 can be adjusted to approach the ideal sine wave W5, that is, to have the same peak value and period. The difference between the waveform area of a single phase of the induced electromotive force waveform W4 of the three-phase axial flux motor 1 and the waveform area of the ideal sine wave W5 can be less than 5%.

In step S14, a sinusoidal driving phase voltage is input to the three coils of the stator, so that the driving phase currents flowing through the three coils are in approximative sine waves. In the adjusted three-phase axial flux motor 1, a sinusoidal phase voltage is input again to the coils to generate the driving phase current of an approximative sine wave. The driving phase current of an approximative sine wave excites the stator 11 and the rotor 12 to drive the rotor 12 to rotate stably.

To sum up, the three-phase axial flux motor of the invention includes a stator, a rotor and a driving unit. The driving unit outputs a sinusoidal phase voltage to the coil to generate a driving phase current. When the rotor rotates stably, the coil of the stator generates an inductance waveform and an induced electromotive force waveform. By adjusting the slots of the stator, the design of the coil, or the magnetizing state of the magnet, the inductance waveform and the induced electromotive force waveform are adjusted. The difference between the area of the adjusted induced electromotive force waveform and the area of the ideal sine wave having the same peak value and period should be less than 5%. Subsequently, the driving phase current is generated to flow through the coil to excite the magnetic fields of the stator and the rotor to drive the rotor to rotate stably. The method of adjusting the magnetic path of the three-phase axial flux motor of the invention adjusts the inductance waveform and the induced electromotive force waveform of the three-phase axial flux motor to approach an ideal sine wave. Afterwards, a sinusoidal phase voltage is input to the coil to generate a driving phase current having an approximative sine wave to reduce the high frequency noise during operation and effectively improve the power performance.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A three-phase axial flux motor, comprising:
a stator comprising three coils;
a rotor pivotally connected at the stator, wherein the rotor comprises a magnet, and the magnet has a magnetizing state; and
a driving unit outputting a sinusoidal phase voltage to the coils, wherein the magnetizing state of the magnet is provided in correspondence to an inductance waveform and an IEF (induced electromotive force) waveform to let a waveform of a driving phase current flowing through the coils be an approximative sine wave.

2. The three-phase axial flux motor according to claim 1, wherein the stator comprises a core, the core has a plurality of slots disposed independently to each other, the number of the slots is a multiple of three, and the coils are divided by three sets wound at the slots respectively.

3. The three-phase axial flux motor according to claim 1, wherein the inductance waveform and the IEF waveform of the stator are approximative sine waves.

4. The three-phase axial flux motor according to claim 1, wherein the ripple error of the inductance waveform in each phase is 78% to 80%, and the maximum value difference and the minimum value difference between the phases are less than 1%.

5. The three-phase axial flux motor according to claim 1, wherein the difference between the waveform area of the IEF waveform and the waveform area of the sine wave having the same peak value and period is less than 5%.

6. The three-phase axial flux motor according to claim 2, wherein the core is made of a soft magnetic composite material.

7. The three-phase axial flux motor according to claim 1, wherein the driving unit is a PWM (pulse width modulation) driving unit.

8. The three-phase axial flux motor according to claim 1, wherein the magnetizing state of the magnet comprises the number, the shape, the distribution and the strength of magnet poles.

9. The three-phase axial flux motor according to claim 2, wherein the stator further comprises an insulation frame mounted on the core, and the coils are wound at the insulation frame.

10. A magnetic path adjusting method of a three-phase axial flux motor, comprising the steps of:
providing the three-phase flux motor, wherein the motor comprises a stator and a rotor;
driving the rotor to rotate by another motor, wherein the stator generates an inductance waveform and an IEF (induced electromotive force) waveform;
adjusting the inductance waveform and the IEF waveform of the stator; and
inputting a sinusoidal driving phase voltage to three coils of the stator to let the driving phase current flowing through the three coils be an approximative sine wave.

11. The magnetic path adjusting method according to claim 10, wherein the step of adjusting the inductance waveform and the IEF waveform of the stator is to adjust the inductance waveform and the IEF waveform to be approximative sine waves.

12. The magnetic path adjusting method according to claim 11, wherein the inductance waveform and the IEF waveform are adjusted by adjusting a magnetizing state of a magnet of the rotor.

13. The magnetic path adjusting method according to claim 11, wherein the shape of the coils of the stator and the design of the shape of the slots are modified to adjust the inductance waveform and the IEF waveform.

14. The magnetic path adjusting method according to claim 10, wherein the difference between the waveform area of the adjusted IEF waveform and the waveform area of the ideal sine wave having the same peak value and period is less than 5%.

15. The magnetic path adjusting method according to claim 10, wherein the ripple error of the adjusted inductance waveform in each phase is 78% to 80%, and the maximum value difference and the minimum value difference between the phases are less than 1%.
